(19) United States
(12) Patent Application Publication
(10) Pub. No.: US 2016/0188671 A1
(43) Pub. Date: Jun. 30, 2016

(54) Methods and Systems for Recommending Applications

(71) Applicant: Facebook, Inc., Menlo Park, CA (US)

(72) Inventors: Vishu Gupta, Atherton, CA (US); Victor Barbosa de Oliveira Medeiros, San Francisco, CA (US)

(21) Appl. No.: 14/585,004

(22) Filed: Dec. 29, 2014

(51) Int. Cl. G06F 17/30; H04L 29/08; H04L 12/58

(52) U.S. Cl. CPC G06F 17/30528; H04L 51/26; H04L 67/22; G06F 17/3051; G06F 17/30867

(57) ABSTRACT

In an electronic device having one or more processors and memory storing instructions for execution by the one or more processors, a trigger event for a user of a social-networking service is detected. Based at least in part on detecting the trigger event for the user of the social-networking service, a recommendation of an application to be run on a client device of the user is provided.

### TECHNICAL FIELD

This relates generally to recommending applications, including but not limited to providing recommendations of mobile device applications.

### BACKGROUND

The growing base of mobile device applications available to users satisfies a wide range of needs, providing consumers with both a source of entertainment and a variety of convenient features and functionality.

Given the overwhelming number of options available, consumers are often unaware of existing applications from which they may benefit and that may suit their interests.

### SUMMARY

Accordingly, there is a need for methods, systems, and interfaces for providing recommendations of applications to be downloaded, installed, and/or run on a client device of a user. By detecting trigger events for the user, applications in which the user may be interested will be recommended to the user. Such methods and interfaces optionally complement or replace conventional methods for downloading, installing, and/or running applications.

In accordance with some embodiments, a method is performed at an electronic device (e.g., a server system) with one or more processors and memory storing instructions for execution by the one or more processors. The method includes providing a recommendation of an application to be run on a client device of the user, based at least in part on detecting a trigger event for a user of a social-networking service.

In accordance with some embodiments, an electronic device (e.g., a server system) includes one or more processors, memory, and one or more programs; the one or more programs are stored in the memory and configured to be executed by the one or more processors. The one or more programs include instructions for performing the operations of the method described above. In accordance with some embodiments, a non-transitory computer-readable storage medium has stored therein instructions that, when executed by the electronic device, cause the electronic device to perform the operations of the method described above.

Thus, electronic devices are provided with efficient and effective methods for providing recommendations of applications to be downloaded, installed, or run on a client device, thereby increasing the effectiveness and efficiency of such devices and user satisfaction with such devices.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating an exemplary network architecture of a social network in accordance with some embodiments.

FIG. 2 is a block diagram illustrating an exemplary social-network system in accordance with some embodiments.

FIG. 3 is a block diagram illustrating an exemplary client device in accordance with some embodiments.

FIGS. 4A-4C illustrate exemplary graphical user interfaces (GUIs) for providing recommendations of applications, in accordance with some embodiments.

FIGS. 5A-5D are flow diagrams illustrating methods for providing recommendations of applications, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first trigger event could be termed a second trigger event, and, similarly, a second trigger event could be termed a first trigger event, without departing from the scope of the various described embodiments. The first trigger event and the second trigger event are both trigger events, but they are not the same trigger event.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

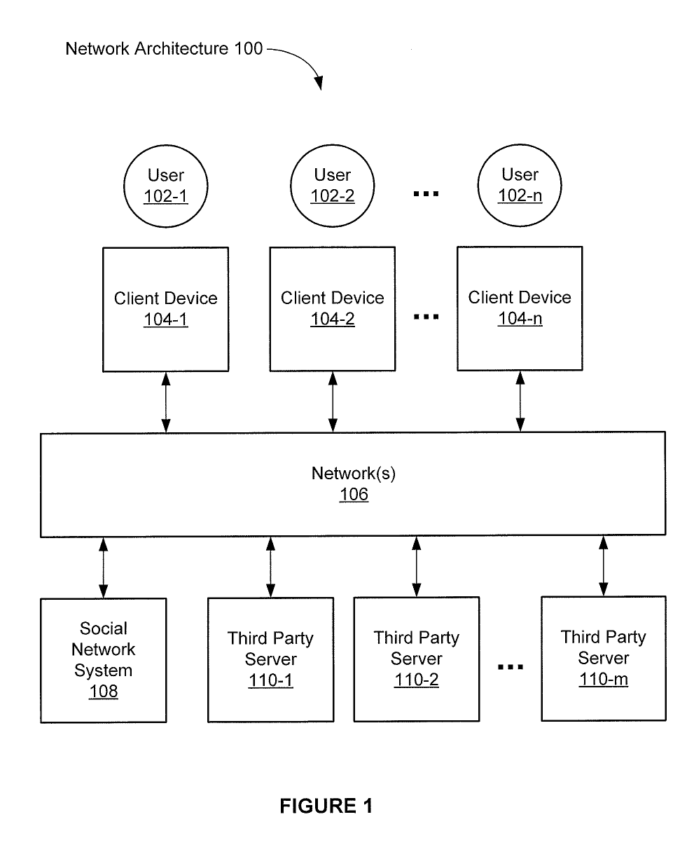

FIG. 1 is a block diagram illustrating an exemplary network architecture 100 of a social network in accordance with some embodiments. The network architecture 100 includes a number of client devices (also called “client systems,” “client computers,” or “clients”) 104-1, 104-2, . . . 104-n communicably connected to an electronic social-network system 108 by one or more networks 106 (e.g., the Internet, cellular telephone networks, mobile data networks, other wide area networks, local area networks, metropolitan area networks, and so on). In some embodiments, the one or more networks 106 include a public communication network (e.g., the Internet and/or a cellular data network), a private communications network (e.g., a private LAN or leased lines), or a combination of such communication networks.

In some embodiments, the client devices 104-1, 104-2, . . . 104-n are computing devices such as smart watches, personal digital assistants, portable media players, smart phones, tablet computers, 2D gaming devices, 3D (e.g., virtual reality) gaming devices, virtual reality headsets, wearable computing devices, laptop computers, desktop computers, televisions with one or more processors embedded therein or coupled thereto, in-vehicle information systems (e.g., an in-car computer system that provides navigation, entertainment, and/or other information), and/or other appropriate computing devices that can be used to communicate with the social-network system 108. In some embodiments, the social-network system 108 is a single computing device such as a computer server, while in other embodiments, the social-network system 108 is implemented by multiple computing devices working together to perform the actions of a server system (e.g., cloud computing).

Users 102-1, 102-2, . . . 102-n employ the client devices 104-1, 104-2, . . . 104-n to access the social-network system 108 and to participate in a corresponding social-networking service provided by the social-network system 108. For example, one or more of the client devices 104-1, 104-2, . . . 104-n execute web browser applications that can be used to access the social-networking service. As another example, one or more of the client devices 104-1, 104-2, . . . 104-n execute software applications that are specific to the social-networking service (e.g., social-networking “apps” running on smart phones or tablets, such as a Facebook social-networking application running on an iPhone, Android, or Windows smart phone or tablet).

Users interacting with the client devices 104-1, 104-2, . . . 104-n can participate in the social-networking service provided by the social-network system 108 by providing and/or consuming (e.g., posting, writing, viewing, publishing, broadcasting, promoting, recommending, sharing) digital information, such as text comments (e.g., statuses, updates, announcements, replies, location “check-ins,” private/group messages), photos, videos, audio files, links, documents, and/or other electronic content. In some embodiments, users interact with a page, group, event, message board, feed, application, and/or user profile of a social-networking service provided by the social network system 108. Users of the social-networking service can annotate information posted by other users of the social-networking service (e.g., endorsing or “liking” a posting of another user, or commenting on a posting by another user). In some embodiments, information can be posted on a user's behalf by systems and/or services external to the social-network system 108. For example, the user may post a review of a movie to a movie-review website, and with proper permissions that website may cross-post the review to the social network system 108 on the user's behalf. In another example, a software application executing on a mobile client device, with proper permissions, may use global positioning system (GPS) or other geo-location capabilities (e.g., Wi-Fi or hybrid positioning systems) to determine the user's location and update the social network system 108 with the user's location (e.g., “At Home,” “At Work,” or “In San Francisco, Calif.”), and/or update the social network system 108 with information derived from and/or based on the user's location. Users interacting with the client devices 104-1, 104-2, . . . 104-n can also use the social-networking service provided by the social-network system 108 to define groups of users, to communicate and collaborate with each other, and/or to install and run applications provided through the social-networking service.

In some embodiments, the network architecture 100 also includes third-party servers 110-1, 110-2, . . . 110-m. In some embodiments, a given third-party server 110 is used to host third-party websites that provide web pages to client devices 104, either directly or in conjunction with the social-network system 108. In some embodiments, the social-network system 108 uses inline frames (“iframes”) to nest independent websites within a user's social network session. In some embodiments, a given third-party server is used to host third-party applications that are used by client devices 104, either directly or in conjunction with the social-network system 108. In some embodiments, the social-network system 108 uses iframes to enable third-party developers to create applications that are hosted separately by a third-party server 110, but operate within a social-networking session of a user 102 and are accessed through the user's profile in the social-network system 108. Exemplary third-party applications include applications for books, business, communication, contests, education, entertainment, fashion, finance, food and drink, games, health and fitness, lifestyle, local information, movies, television, music and audio, news, photos, video, productivity, reference material, security, shopping, sports, travel, utilities, and the like. In some embodiments, a given third-party server 110 is used to host enterprise systems, which are used by client devices 104, either directly or in conjunction with the social-network system 108. In some embodiments, a given third-party server 110 is used to provide third-party content (e.g., news articles, reviews, message feeds, etc.).

In some embodiments, a given third-party server 110 is a single computing device, while in other embodiments, a given third-party server 110 is implemented by multiple computing devices working together to perform the actions of a server system (e.g., cloud computing).

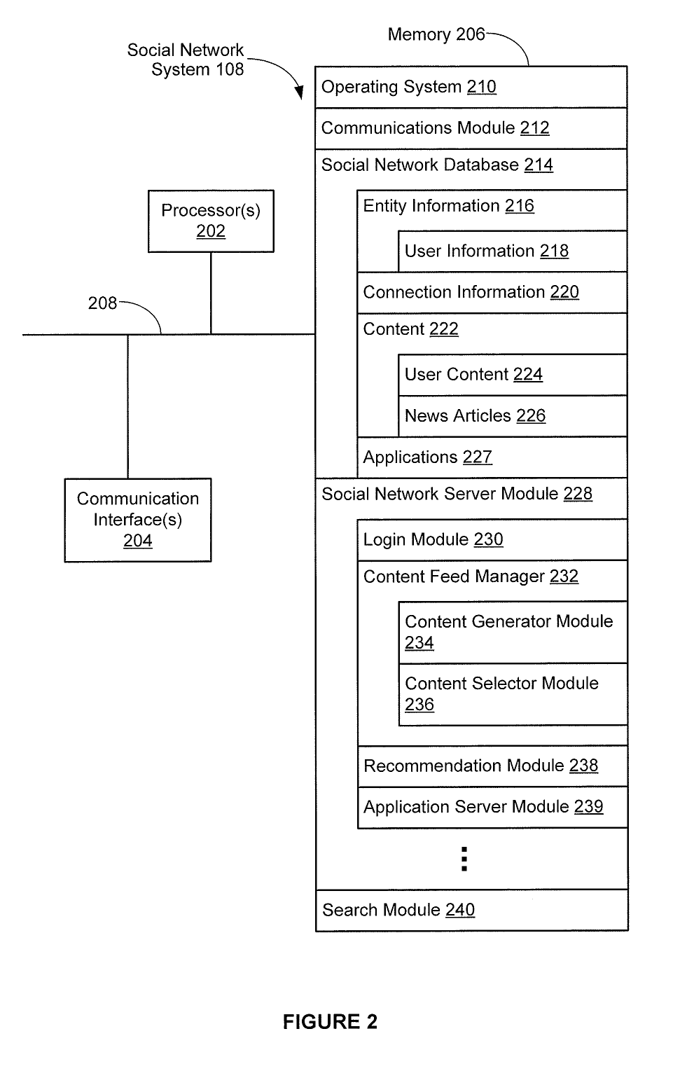

FIG. 2 is a block diagram illustrating an exemplary social-network system 108 in accordance with some embodiments. The social-network system 108 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The social-network system 108 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

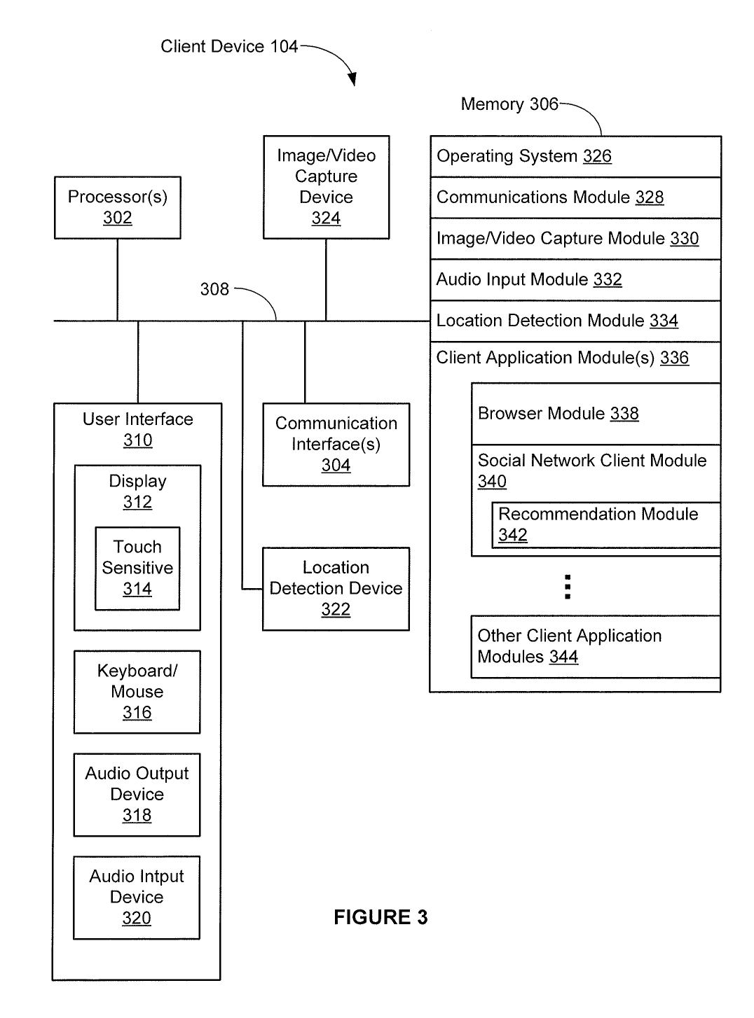

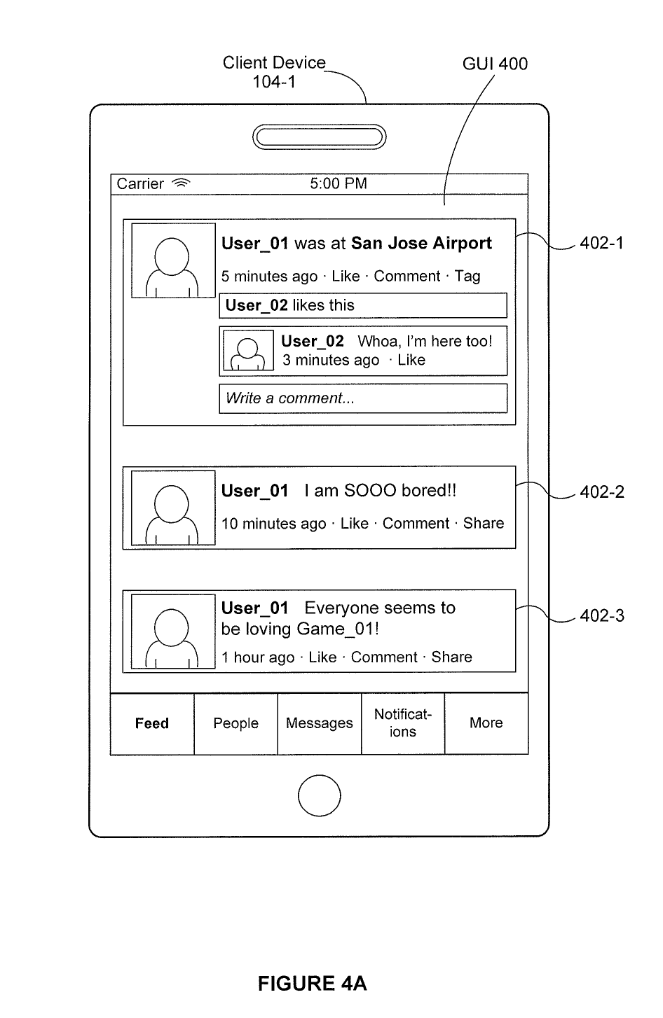

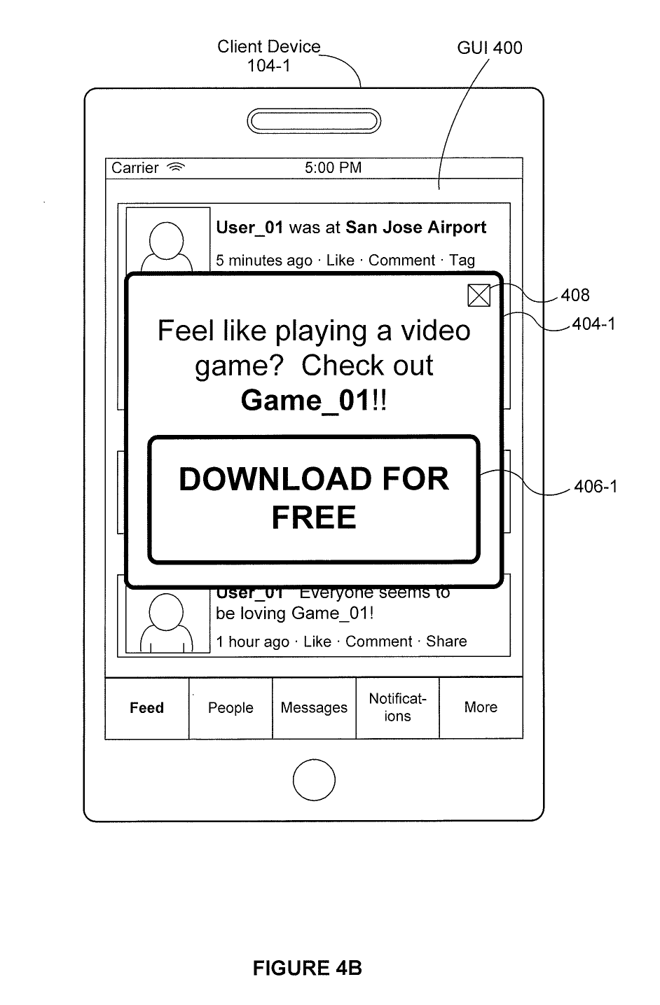

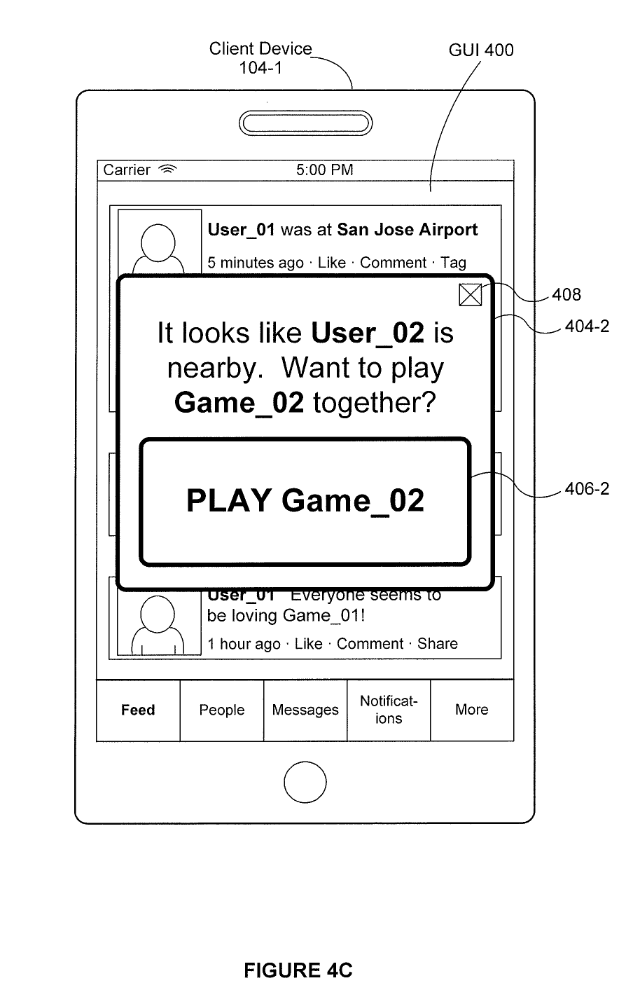

Memory 206 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 206 may optionally include one or more storage devices remotely located from the processor(s) 202. Memory 206, or alternately the non-volatile memory device(s) within memory 206, includes a non-transitory computer-readable storage medium. In some embodiments, memory 206 or the computer-readable storage medium of memory 206 stores the following programs, modules and data structures, or a subset or superset thereof:
an operating system 210 that includes procedures for handling various basic system services and for performing hardware dependent tasks;
a network communication module 212 that is used for connecting the social-network system 108 to other computers via the one or more communication network interfaces 204 (wired or wireless) and one or more communication networks (e.g., the one or more networks 106)
a social network database 214 for storing data associated with the social network, such as:
   entity information 216, such as user information 218;
   connection information 220;
   content 222, such as user content 224 and/or news articles 226; and
   applications 227 available for downloading;
a social network server module 228 for providing social-networking services and related features (e.g., in conjunction with browser module 338 or social network client module 340 on the client device 104, FIG. 3), which includes:
   a login module 230 for logging a user 102 at a client 104 into the social-network system 108; and
   a content feed manager 232 for providing content to be sent to clients 104 for display, which includes:
      a content generator module 234 for adding objects to the social network database 214, such as images, videos, audio files, comments, status messages, links, applications, and/or other entity information 216, connection information 220, or content 222; and
      a content selector module 236 for choosing the information/content to be sent to clients 104 for display;
a recommendation module 238 for detecting trigger events for users (e.g., users 102, FIG. 1) of a social-networking service (e.g., provided by social-network system 108), and, in response, for providing recommendations of applications (e.g., applications 227) to be downloaded, installed, and/or run on client devices (e.g., sending application recommendations 404 for display on client devices 104, FIGS. 4B and 4C);
an application server to download applications (e.g., applications 227) to client devices 104; and/or
a search module 240 for enabling users of the social-network system to search for content and other users in the social network.

The social network database 214 stores data associated with the social network in one or more types of databases, such as graph, dimensional, flat, hierarchical, network, object-oriented, relational, and/or XML databases.

In some embodiments, the social network database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities, some of which are rendered at clients 104 on corresponding profile pages or other pages in the social-networking service. In some embodiments, the nodes also include pointers or references to other objects, data structures, or resources for use in rendering content in conjunction with the rendering of the pages corresponding to the respective nodes at clients 104.

Entity information 216 includes user information 218, such as user profiles, login information, privacy and other preferences, biographical data, and the like. In some embodiments, for a given user, the user information 218 includes the user's name, profile picture, contact information, birth date, sex, marital status, family status, employment, education background, preferences, interests, and/or other demographic information.

In some embodiments, entity information 216 includes information about a physical location (e.g., a restaurant, theater, landmark, city, state, or country), real or intellectual property (e.g., a sculpture, painting, movie, game, song, idea/concept, photograph, or written work), a business, a group of people, and/or a group of businesses. In some embodiments, entity information 216 includes information about a resource, such as an audio file, a video file, a digital photo, a text file, a structured document (e.g., web page), or an application. In some embodiments, the resource is located in the social-network system 108 (e.g., in content 222) or on an external server, such as third-party server 110.

In some embodiments, connection information 220 includes information about the relationships between entities in the social network database 214. In some embodiments, connection information 220 includes information about edges that connect pairs of nodes in a graph database. In some embodiments, an edge connecting a pair of nodes represents a relationship between the pair of nodes.

In some embodiments, an edge includes or represents one or more data objects or attributes that correspond to the relationship between a pair of nodes. For example, when a first user indicates that a second user is a “friend” of the first user, the social-network system 108 transmits a “friend request” to the second user. If the second user confirms the “friend request,” the social-network system 108 creates and stores an edge connecting the first user's user node and the second user's user node in a graph database as connection information 220 that indicates that the first user and the second user are friends. In some embodiments, connection information 220 represents a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In some embodiments, an edge between a user node and another entity node represents connection information about a particular action or activity performed by a user of the user node towards the other entity node. For example, a user may “like” or have “attended,” “played,” “listened,” “cooked,” “worked at,” or “watched” the entity at the other node. The page in the social-networking service that corresponds to the entity at the other node may include, for example, a selectable “like,” “check in,” or “add to favorites” icon. After the user clicks one of these icons, the social-network system 108 may create a “like” edge, “check in” edge, or a “favorites” edge in response to the corresponding user action. As another example, the user may listen to a particular song using a particular application (e.g., an online music application). In this case, the social-network system 108 may create a “listened” edge and a “used” edge between the user node that corresponds to the user and the entity nodes that correspond to the song and the application, respectively, to indicate that the user listened to the song and used the application. In addition, the social-network system 108 may create a “played” edge between the entity nodes that correspond to the song and the application to indicate that the particular song was played by the particular application.

In some embodiments, content 222 includes text (e.g., ASCII, SGML, HTML), images (e.g., jpeg, tif and gif), graphics (e.g., vector-based or bitmap), audio, video (e.g., mpeg), other multimedia, and/or combinations thereof. In some embodiments, content 222 includes executable code (e.g., games executable within a browser window or frame), podcasts, links, and the like.

In some embodiments, user content 224 includes text comments (e.g., statuses, updates, announcements, replies, location “check-ins,” private/group messages), photos, videos, audio files, links, documents, and/or other electronic content. In some embodiments, user content 224 further includes user annotations of information posted by other users of the social-networking service (e.g., endorsements or “likes” of another user's posting, comments on another user's posting, etc.).

In some embodiments, the social network server module 228 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

In some embodiments, the recommendation module 238 selects (e.g., ranks) applications for recommendation based on a variety of factors (e.g., user profile, application popularity, detected trigger events, etc.).

FIG. 3 is a block diagram illustrating an exemplary client device 104 in accordance with some embodiments. The client device 104 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 104 includes a user interface 310. The user interface 310 typically includes a display device 312. In some embodiments, the client device 104 includes inputs such as a keyboard, mouse, and/or other input buttons 316. Alternatively or in addition, in some embodiments, the display device 312 includes a touch-sensitive surface 314, in which case the display device 312 is a touch-sensitive display. In client devices that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 104 use a microphone and voice recognition to supplement or replace the keyboard. Optionally, the client device 104 includes an audio input device 320 (e.g., a microphone) to capture audio (e.g., speech from a user). Optionally, the client device 104 includes a location detection device 322, such as a GPS (global positioning satellite) or other geo-location receiver, for determining the location of the client device 104. The client device 104 also optionally includes an image/video capture device 324, such as a camera or webcam.

Memory 306 includes high-speed random-access memory, such as DRAM, SRAM, DDR RAM or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 302. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 326 that includes procedures for handling various basic system services and for performing hardware dependent tasks;
a network communication module 328 that is used for connecting the client device 104 to other computers via the one or more communication network interfaces 304 (wired or wireless) and one or more communication networks, such as the Internet, cellular telephone networks, mobile data networks, other wide area networks, local area networks, metropolitan area networks, and so on;
an image/video capture module 330 (e.g., a camera module) for processing a respective image or video captured by the image/video capture device 324, where the respective image or video may be sent or streamed (e.g., by a client application module 336) to the social-network system 108;
an audio input module 332 (e.g., a microphone module) for processing audio captured by the audio input device 320, where the respective audio may be sent or streamed (e.g., by a client application module 336) to the social-network system 108;
a location detection module 334 (e.g., a GPS, Wi-Fi, or hybrid positioning module) for determining the location of the client device 104 (e.g., using the location detection device 322) and providing this location information for use in various applications (e.g., social network client module 340); and
one or more client application modules 336, including the following modules (or sets of instructions), or a subset or superset thereof:
   a web browser module 338 (e.g., Internet Explorer by Microsoft, Firefox by Mozilla, Safari by Apple, or Chrome by Google) for accessing, viewing, and interacting with web sites (e.g., a social-networking web site provided by the social-network system 108),
   a social network module 340 for providing an interface to a social network (e.g., a social network provided by social-network system 108) and related features;
   (optional) recommendation module 342 (e.g., within the social network module 340) for detecting trigger events for a user (e.g., user 102 of the client device 104) of a social-networking service (e.g., provided by the social-network system 108), and/or for providing, in response to trigger events, recommendations (e.g., recommendations 404, FIGS. 4B-4C) of applications to be downloaded, installed, and/or run on client device 104; and/or
   optional client application modules 344, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

In some embodiments, respective client application modules 344 are downloaded and installed through a social-networking service (e.g., provided by social-network system 108) or a third-party server (e.g., third-party servers 110, FIG. 1)

In some embodiments, the optional recommendation module 342 is analogously configured to the recommendation module 238 of the social-network system 108 (FIG. 2).

Each of the above identified modules and applications corresponds to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

Attention is now directed towards embodiments of graphical user interfaces (“GUIs”) and associated processes that may be implemented on a client device (e.g., the client device 104, FIG. 3).

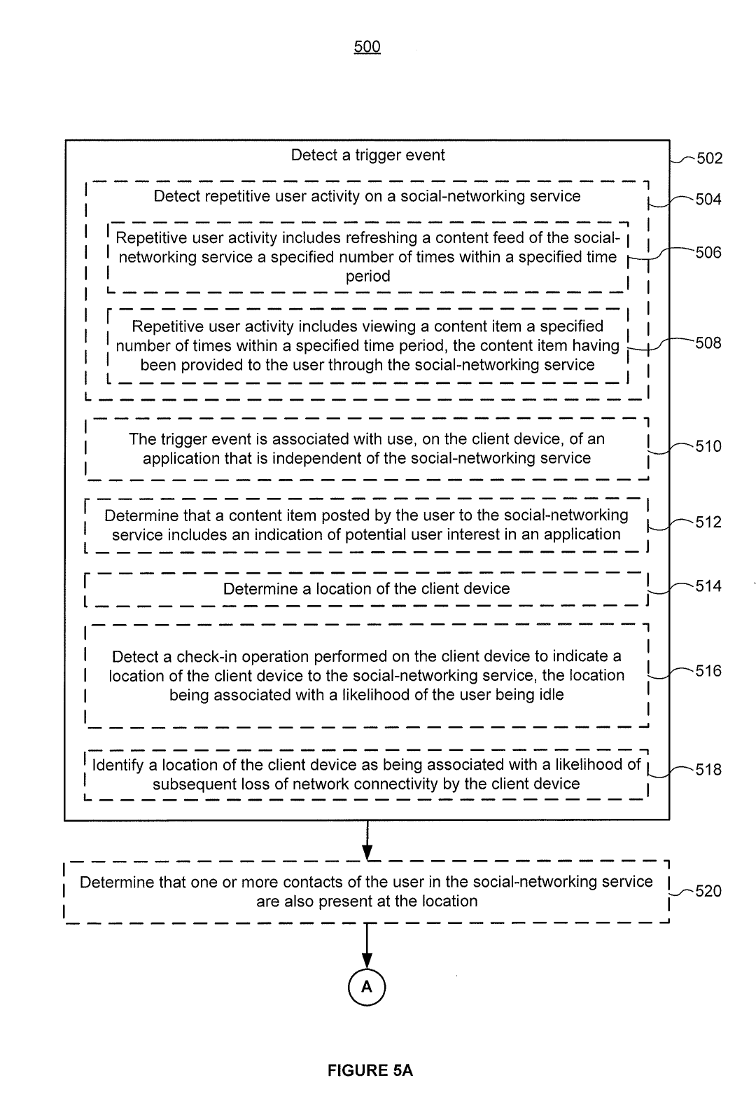

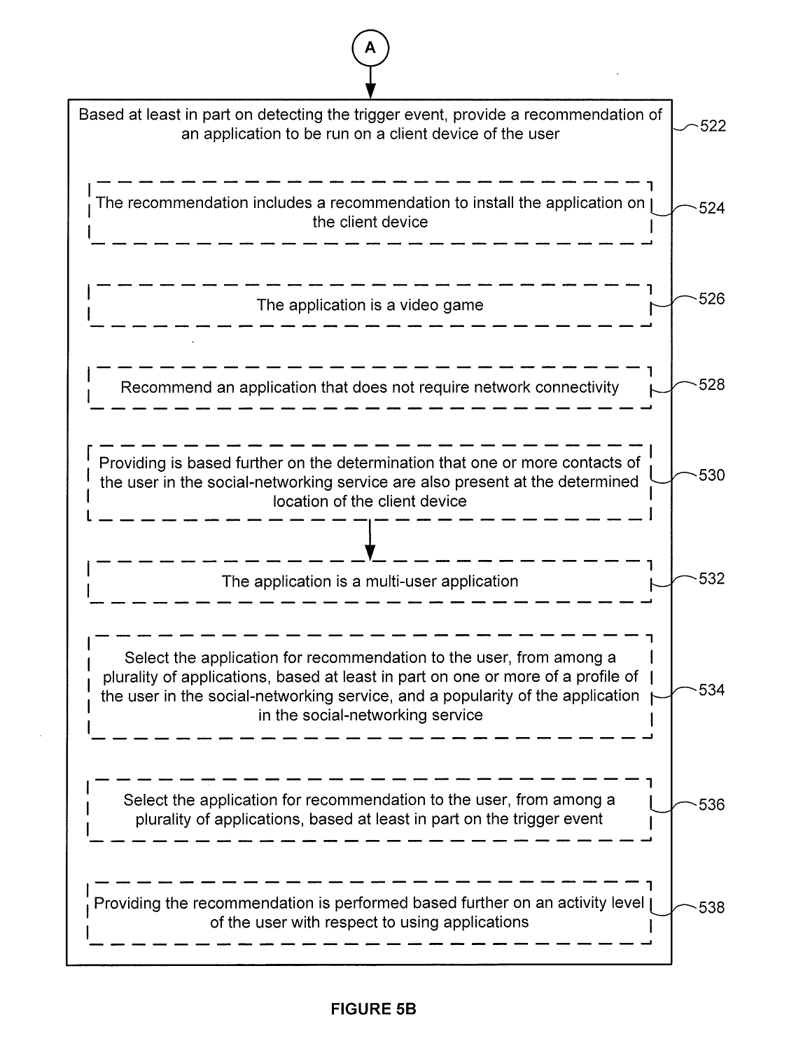

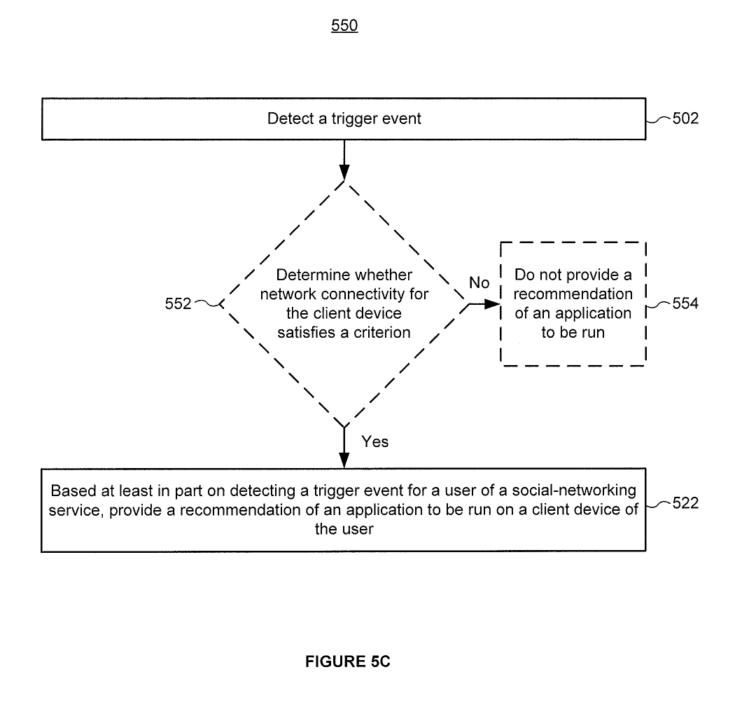

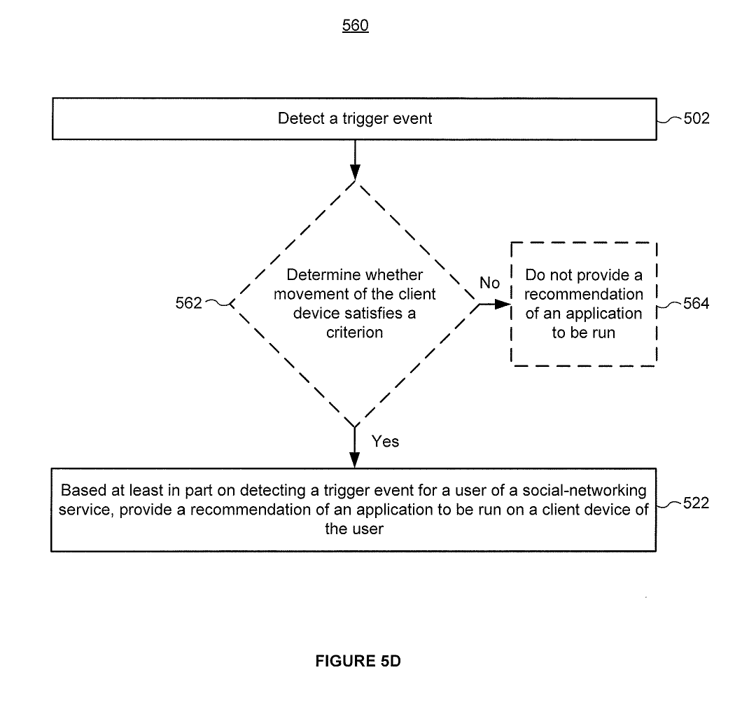

FIGS. 4A-4C illustrate an exemplary GUI 400, shown on a display of client device 104-1, for providing recommendations of applications, in accordance with some embodiments. The GUI 400 illustrates the processes described below, including the methods 500, 550, and 560 (FIGS. 5A-5D). While FIGS. 4A-4C illustrate examples of GUIs, in other embodiments, a GUI displays user-interface elements in arrangements distinct from the embodiments of FIGS. 4A-4C.

FIG. 4A illustrates an exemplary GUI 400 of an application (e.g., a social network client module 340, FIG. 3) for providing an interface to a social-networking service (e.g., provided by social-network system 108). The GUI 400 includes a feed of user content items 402 for display to the user of client device 104-1 (“User_01”).

User content items 402 include different types of user content 224. For example, user content item 402-1 is a location check-in submitted by “User_01” (e.g., “User_01” performed a check-in operation, indicating that the user was located at “San Jose Airport”). As additional examples, user content items 402-2 and 402-3 are personal statuses published by “User_01” to the social-networking service (“I am SOOO bored!!,” “Everyone seems to be loving Game_01!”).

Triggers are events or situations in which there is a likelihood that a recommendation of an application would be valuable to the user of a device. Based at least in part on detecting a trigger event, a recommendation of an application is provided.

Trigger events may include detecting that a user has checked into a location that is associated with a likelihood of the user being idle. For example, user content item 402-1 is a location check-in at an airport, which is associated with a likelihood of the user being idle (the user is presumed to be idle when waiting to board the plane, boarded on the plane and in transit). Based on the detected location of the user, trigger events may also include determining that one or more contacts of the user in the social-networking service are also present at the location. For example, the comment of “User_02” (“Whoa, I'm here too!”) in response to the location check-in of “User_01” indicates that “User_02” is also present at the same location as “User_01.” Because “User_01” and “User_02” are in the same location, they might be interested in playing a game or using another type of application together. (Alternatively, “User_01” might be idle while waiting for “User_02” to finish doing something—e.g., shopping—at a given location.) In some embodiments, trigger events may include detecting that a user has not relocated for more than a predefined period of time (e.g., user has remained in the same location for more than 3 hours).

Trigger events may also include determining that a content item posted by a user to a social-networking service includes an indication of potential user interest in an application (e.g., based on keywords or phrases detected in user content). For example, user content item 402-2 includes a keyword, “bored,” which indicates potential user interest in using an application, such as a video game. As another example, user content item 402-3 includes the title of a video game application, “Game_01,” which indicates potential user interest in video game applications, and also the specific video game application “Game_01.”

FIGS. 4B and 4C illustrate examples of application recommendations 404 that are provided based at least in part on detected trigger events, such as the examples given in FIG. 4A. User interface elements 406 are also displayed (“DOWNLOAD FOR FREE,” “PLAY Game_02”), selection of which accepts the recommendation and causes the recommended application to be downloaded and/or executed. Selection of user interface element 408 rejects the recommendation and causes display of a recommendation 404 to end.

In some embodiments, selection of an application for recommendation to the user is based on the detected trigger event. For example, as shown by the application recommendation 404-1 (FIG. 4B), “Game 01” is selected for recommendation to “User_01” (the user of client device 104-1) based on the detected trigger event in user content item 402-3 (e.g., post by “User_01,” stating “Everyone seems to be loving Game_01 !,” FIG. 4A). Therefore, in some cases, both providing the application recommendation, and selection of the recommended application, are based on the detected trigger event.

As another example, the application recommendation 404-2 (FIG. 4C) reflects the detected trigger event in user content item 402-1 (FIG. 4A), which indicates that “User_02” has been detected nearby “User_01.” Based on the detected trigger event, “Game_02,” a multi-player game, is selected for recommendation to “User_01.” In this case, both providing the application recommendation, and selection of the recommended application, are based on the detected trigger event.

These examples of application recommendations 404, and the recommended applications themselves, may be based on other trigger events, some of which are described in greater detail with respect to FIGS. 5A-5D.

FIGS. 5A-5D are flow diagrams illustrating methods 500 (FIGS. 5A-5B), 550 (FIG. 5C), and 560 (FIG. 5D) of providing recommendations of applications, in accordance with some embodiments. The methods 500, 550, and 560 are performed on an electronic device (e.g., client device 104, FIGS. 1 and 3, where client device 104 acts as a standalone device). In some embodiments, the methods 500, 550, and 560 are performed by executing instructions stored in the memory of an electronic device (e.g., in a recommendation module 238 or 342, FIG. 2 or 3). In some embodiments, the methods 500, 550, and 560 are performed by a server device (e.g., social network system 108, FIGS. 1 and 2) that sends information to a client device for display. In some embodiments, the methods 500, 550, and 560 are performed in part by an electronic device (e.g., client device 104) and in part by a server device (e.g., social network system 108). In an example in which the electronic device is a server system (e.g., social network system 108) associated with the social-networking service, detecting (operation 502) a trigger event includes receiving an indication of the trigger event from a client device (e.g., client device 104), and providing (operation 522) a recommendation includes sending the recommendation to the client device for display. It will be understood that, in various embodiments, respective operations of methods 500, 550, and 560 are performed by any of the aforementioned devices or combination of devices. FIGS. 5A-5D correspond to instructions stored in a computer memory or other computer-readable storage medium (e.g., memory 206 of the social network system 108 and/or memory 306 of the client device 104).

In performing the method 500, an electronic device detects (502) a trigger event for a user of a social-networking service (e.g., user 102-1 of client device 104-1, FIG. 1). As described above, triggers are events or situations in which there is a likelihood that a recommendation of an application would be valuable to the user of a client device. In some cases, trigger events suggest that a user is potentially interested in a form of entertainment provided by an application (e.g., a video game application). Alternatively, trigger events may suggests that a user is potentially interested in a feature or functionality provided by an application (e.g., a health monitoring application).

In some embodiments, detecting (502) a trigger event includes detecting (504) repetitive user activity on the social-networking service. For example, in some embodiments, repetitive user activity includes refreshing (506) a content feed (e.g., a feed displayed by the GUI 400, FIG. 4A) of the social-networking service a specified number of times within a specified time period. In some embodiments, repetitive user activity includes viewing (508) a content item a specified number of times within a specified time period (e.g., viewing a news article posted by another user 5 times within an hour), the content item having been provided to the user through the social-networking service.

In some embodiments, the trigger event is associated (510) with use, on the client device, of an application (e.g., browser module 338, FIG. 3) that is independent of the social-networking service (e.g., social network client module 340, FIG. 3). Trigger events associated with the use of an independent application on a client device include, for example, a user playing a video game (e.g., a third-party video game external to the social-networking service), or keywords detected in content displayed in a third-party application (e.g., keywords detected in a search query, web browser, article being viewed, etc.). In some embodiments, trigger events are associated with general user activity on the client device (e.g., repetitive activity in viewing content stored on the client device, such as digital photos in an album).

In some embodiments, detecting (502) a trigger event includes determining (512) that a content item (e.g., status update) posted by the user to the social-networking service includes an indication of potential user interest in an application. Indications of potential user interest may include keywords or phrases suggesting that the user seeks some form of entertainment (e.g., keyword “bored” in user content item 402-2, FIG. 4A) or other functionality. Indications of potential user interest may also include explicit references made to the title of an application (e.g., reference to “Game_01” in user content item 402-3, FIG. 4A) or other aspect of an application (e.g., reference to a video game character or nickname for a video game). Content items may include other indications of potential user interest in the application, derived from the text of comments (published by the user, or other users of the social-networking service who are associated with the user), and/or text found in an article/document to which the user has posted a link or which the user has liked or commented on. Indications of potential user interest in the application can also be derived from other electronic content (e.g., media files, such as photos, videos, audio clips) that includes some association with the application. For example, photos posted by a user that show the logo of a mobile application developer indicate potential user interest in applications of the developer.

In some embodiments, detecting (502) a trigger event includes determining (514) a location of the client device. The location of the client device may correspond to a specific set of coordinates (e.g., GPS coordinates), a geo-fence (e.g., a virtual perimeter corresponding to a predefined geographic area), or other defined region.

In some implementations, the determined location of the client device is associated with a likelihood of the user being idle (e.g., an airport, train station, bus station, shopping mall, medical office, or governmental office, etc.). These locations suggest a likelihood that a recommendation of an application would be valuable to the user. Optionally, the determined location of the client device may also be used to determine (520) that one or more contacts of the user in the social-networking service are also present at the location (e.g., within a threshold distance from the location).

In some embodiments, detecting (502) the trigger event includes detecting (516) a check-in operation performed on the client device to indicate a location of the client device to the social-networking service, the location being associated with a likelihood of the user being idle (e.g., an airport). For example, referring to FIG. 4A, a trigger event is detected in user content item 402-1 when “User_01” performs a location check-in operation at “San Jose Airport” (e.g., using a check-in feature of social network client module 340, FIG. 3). Alternatively, an automatically determined location of the client device (i.e., determined without user input such as a check-in command) serves as the trigger event.

In some embodiments, detecting (502) a trigger event includes identifying (518) a location of the client device as being associated with a likelihood of subsequent loss of network connectivity by the client device. A subsequent loss of network connectivity may suggest that a recommendation of an application will be valuable to the user during a later time when, and at a location where, network connectivity is unavailable. For example, the electronic device detects a trigger event if it detects that the user is located at an airport. This is based on the assumption that the user will not have access to network connectivity once on-board the plane, a situation in which there is a likelihood that a recommendation of an application (e.g., that does not require network access) would be valuable to the user of the client device (e.g., a video game application to occupy the user's time in transit).

In some embodiments, the activity of the user in the social-networking service is monitored, and machine learning is applied to the monitored activity to determine the trigger event. Machine learning thus may be used to specify one or more conditions that define, or a part of, the trigger event. By applying machine learning techniques, potential user interest in an application can be better gauged by identifying which trigger events are more determinative of the user's interest.

Referring now to FIG. 5B, in some embodiments, based at least in part on detecting the trigger event, the electronic device provides (522) a recommendation of an application to be run on the client device of the user. In some embodiments, the recommendation includes a recommendation to install (524) (and/or download) the application on the client device.

In some embodiments, the recommended application is (526) a video game. The video game may be accessed via the social network system (e.g., downloaded and/or run through social network client module 340, FIG. 3). Alternatively, the video game is a third-party game external to the application for the social-networking service (e.g., downloaded from third party server 110-1, FIG. 1). In some embodiments, the recommended application is either a paid application (e.g., that the user must pay for to install and/or run) or non-paid (i.e., free) application. Examples of different applications (e.g., third-party applications, applications obtained through the social-networking service, etc) that may be downloaded, installed, and/or executed are described with respect to FIGS. 1 through 3.

In some embodiments, providing (522) the recommendation includes recommending (528) an application that does not require network connectivity. Optionally, recommending (528) is performed in accordance with identifying (518) a location of the client device as being associated with a likelihood of subsequent loss of network connectivity by the client device. For example, a trigger event is detected based on the location check-in of “User_01” at the airport (user content item 402-1, FIG. 4A), as airports are identified as being associated with a likelihood of subsequent loss of network connectivity (assuming “User_01” boards a flight without network connectivity). Consequently, in addition to providing a recommendation based on, and thus in response to, detecting the trigger event, the application to be recommended may be selected based on the trigger event, which indicates a likelihood of subsequent loss of network connectivity: the selected application is an application that does not require network connectivity.

In some embodiments, providing (522) the recommendation is based further on the determination (530) that one or more contacts of the user in the social-networking service are also present at a determined location (520) of the client device of the user. The recommended application may be (532) a multi-user application. For example, referring to FIG. 4A, based on the location check-in (user content item 402-1), the location of “User_01” is determined to be “San Jose Airport.” The subsequent comment by “User_02,” published in response to the location check-in, indicates that “User_02” is also at the same location as “User_01” (“Whoa, I'm here too!”). Consequently, in addition to providing a recommendation based on, and thus in response to, the determination that both “User_01” and “User_02” are present at the same location, the application to be recommended may be selected based on the same determination: the application recommendation 404-2 (FIG. 4C) includes a recommendation of a multi-user application, “Game_02,” that both users can play. (Alternatively, a single-user application is recommended that “User_01” may use while waiting for the one or more contacts to perform a task at the location. For example, if both “User_01” and the spouse/partner of “User_01” are at a store or shopping mall, “User_01” may receive a recommendation of a game to play while the spouse/partner shops.)

In some embodiments, the electronic device selects (534) the application for recommendation to the user, from among a plurality of applications, based at least in part on a profile of the user in the social-networking service. A user profile includes personal information about the user that implicitly or explicitly indicates an interest of the user in the application, the subject matter of the application, and/or a feature/functionality provided by the application (e.g., based on listed hobbies, interests, activities, etc.).

In some embodiments, the electronic device selects the application for recommendation based on the user's browsing history within and/or outside of the social-networking service (e.g., user views a social-media page of the company that develops the application), and/or the user's application purchase history (e.g., recommending applications similar to those the user has already purchased/used, recommending other applications by the developer of one or more applications the user has already purchased/used, etc.).

In some embodiments, the electronic device selects (534) the application for recommendation based at least in part on a popularity of the application in the social-networking service. The popularity of an application may be based on a click-through rate, installation rate, and/or a number of contacts of the user in the social-networking service who have used/purchased the application. In some embodiments, selecting the application for recommendation is based at least in part on which applications are used/purchased most by contacts of the user who are considered important contacts. Important contacts include, for example, contacts with an importance designation (e.g., designated as “close friends” or family) or contacts whose published content on the social-networking service the user views with a frequency that satisfies a threshold (e.g., an absolute threshold, or a threshold defined in comparison to other contacts).

In some embodiments, the electronic device selects (536) the application for recommendation based at least in part on the trigger event. For example, referring to FIG. 4A, a trigger event is detected when the “User_01” mentions “Game_01” in user content item 402-3, and accordingly, a recommendation for an application is provided to “User_01” (application recommendation 404-1, FIG. 4B). The application recommendation 404-1 includes a recommendation to download “Game_01,” since the trigger event is the detection of “Game_01” in user content item 402-3. Thus, both providing the recommendation and selecting the application to be recommended are based on the same trigger event. In some embodiments, a user content item (e.g., user content item 402-1, FIG. 4A) may include references to shows, movies, characters from such shows or movies, and/or celebrities. In these embodiments, the application for recommendation may be associated with such references. The recommended application may, for example, be an application (e.g., an official/authorized application) associated with the reference, be created by the reference (e.g., a company/developer), and/or include the reference (e.g., one or more characters from a show). For example, user content item 402-1 may read “Loved the last episode of TV_Show_01,” where “TV_Show_01” is represented by a page of the social-networking service. Accordingly, the application recommendation 404-1 (FIG. 4B) may read “Feel like playing a video game? Check out Game_03!,” where “Game_03” is a video game application associated with the show, “TV_Show_01.” Discussions of shows, movies, or other types of media may therefore be used as both a trigger event for providing the recommendation, as well as a basis upon which to select the application for recommendation. In other implementations, providing the recommendation is based at least in part on detecting a first trigger event (e.g., location check-in at an airport, user content item 402-1, FIG. 4A), and selecting the application for recommendation is based at least in part on a second trigger event distinct from the first trigger event (e.g., detecting contacts of the user nearby, user content item 402-1, FIG. 4A).

In some embodiments, a plurality of applications are ranked and an application is selected for recommendation to the user based on the rankings (e.g., the highest ranking application is selected for recommendation). In some embodiments, respective rankings are determined based on one or more variables for selecting and/or providing the recommended application, as discussed above (e.g., the user profile, a popularity of a respective application, detected trigger events, etc.). In some embodiments, one or more (e.g., all) variables used for ranking are independent of the trigger condition.

In some embodiments, providing (522) the recommendation is performed based further on an activity level (538) of the user with respect to using applications. For example, the recommendation is provided based at least in part on a combination of detecting a trigger event and determining that the user's activity level satisfies a threshold. The frequency with which recommendations for applications are provided may be based on a number of applications that the user has used, downloaded, and/or purchased, the frequency with which applications were used over a period of time, and/or the duration of time for which applications are used when executed/run. In some embodiments, recommendations of application to be downloaded/run are provided more frequently to active users of applications (e.g., are provided with a first frequency to users whose activity levels do not satisfy a threshold and with a second, higher frequency to users whose activity levels satisfy the threshold).

In some embodiments, providing (522) the recommendation includes providing to the user an indication of one or more factors based on which the application was selected for recommendation to the user. For example, application recommendation 404-2 (FIG. 4C) indicates that video game application “Game_02” was selected for recommendation because “User_02” (a contact of “User_01”) was detected nearby.

The client device receives user input indicating whether the user accepts or declines the recommendations. For example, the user selects user interface element 406-1 or 406-2 (FIGS. 4B-4C) to accept the recommendation or selects user interface element 408 to reject the recommendation (FIGS. 4B-4C). If the user accepts the recommendation, the recommended application is downloaded, installed, and/or run on the client device. If the user rejects the recommendation, the recommended application is not downloaded, installed, or run on the client device.

Referring now to FIG. 5C, in performing the method 550, the electronic device detects (502) a trigger event (where detecting is performed in accordance with any of the embodiments discussed above with respect to the method 500). The electronic device then determines (552) whether network connectivity for the client device satisfies a criterion. The criterion may be based on a type of detected network connection (e.g., whether client device has Internet connectivity through the cellular network and/or Wi-Fi), a signal strength of the detected network connection (e.g., measured in dBm), or a degree of network congestion.

If the determined network connectivity for the client device does not satisfy the criterion (552—No), a recommendation of an application to be run is not provided (554). For example, if the client device has Internet connectivity through a first type of network (e.g., the cellular network), but does not have connectivity through a second type of network (e.g., Wi-Fi connection), no recommendation is provided so that bandwidth on the first type of network is saved. If the user has connectivity through the second type of network, however, then the recommendation is provided. In another example, the recommendation is provided if the signal strength satisfies (e.g., exceeds, or equals or exceeds) a threshold but not if the signal strength does not satisfy the threshold. In yet another example, the recommendation is not provided if network congestion satisfies (e.g., exceeds, or equals or exceeds) a threshold, but is provided if the network congestion does not satisfy the threshold.

If the determined network connectivity for the client device satisfies the criterion (552—Yes), a recommendation of an application to be run on the client device is provided (522) based at least in part on detecting a trigger event for a user of a social-networking service (where providing the recommendation is performed in accordance with any of the embodiments discussed above with respect to the method 500). In this example, the recommendation is provided based further on the determination (552—Yes) that the network connectivity satisfies the criterion.

Referring now to FIG. 5D, in performing the method 560, the electronic device detects (502) a trigger event (where detecting is performed in accordance with any of the embodiments discussed above with respect to the method 500). The electronic device then determines (562) whether movement of the client device satisfies a criterion. The criterion may be based on whether the client device is moving (e.g., at speeds corresponding to driving in a vehicle, walking, etc.) or stationary.

If the determined movement of the client device does not satisfy the criterion (562—No), a recommendation of an application to be run is not provided (564). For example, if it is determined that the client device is moving at a speed indicative of being in a moving vehicle then a recommendation is not provided as a safety precaution to avoid distracting the user, who may be driving. (In this example, the criterion may specify that the speed be less than, or less than or equal to, a threshold.)

If the determined movement of the client device satisfies the criterion (562—Yes), a recommendation of an application to be run on the client device is provided (522) based at least in part on detecting a trigger event for a user of a social-networking service (where providing the recommendation is performed in accordance with any of the embodiments discussed above with respect to the method 500). In this example, the recommendation is provided based further on the determination (562-Yes) that the movement satisfies the criterion. As another example, if a user is detected as stationary and actively using the client device, then the criterion is satisfied and a recommendation is provided.

Stages of methods 500, 550, and 560 may be performed additionally and/or alternatively to one another. For example, determinations 552 and 562 may be included in the same method, which may also include operation 520.

For situations in which the systems discussed above collect information about users, the users may be provided with an opportunity to opt in/out of programs or features that may collect personal information (e.g., information about a user's preferences or a user's contributions to social content providers). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. Furthermore, some stages may be performed in parallel and/or simultaneously with one other. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at an electronic device having one or more processors and memory storing instructions for execution by the one or more processors:
based at least in part on detecting a trigger event for a user of a social-networking service, providing a recommendation of an application to be run on a client device of the user.

2. The method of claim 1, wherein the recommendation comprises a recommendation to install the application on the client device.

3. The method of claim 1, wherein:
the electronic device comprises a server system associated with the social-networking service;
detecting the trigger event comprises receiving an indication of the trigger event from the client device; and
providing the recommendation comprises sending the recommendation to the client device for display.

4. The method of claim 1, wherein the application is a video game.

5. The method of claim 1, wherein the trigger event comprises repetitive user activity on the social-networking service.

6. The method of claim 5, wherein the repetitive user activity comprises at least one of:
refreshing a content feed of the social-networking service a specified number of times within a specified time period; and
viewing a content item a specified number of times within a specified time period, the content item having been provided to the user through the social-networking service.

7. The method of claim 1, wherein detecting the trigger event comprises determining that a content item posted by the user to the social-networking service includes an indication of potential user interest in the application.

8. The method of claim 1, wherein detecting the trigger event comprises detecting a check-in operation performed on the client device to indicate a location of the client device to the social-networking service, the location being associated with a likelihood of the user being idle.

9. The method of claim 8, wherein:
the location is an airport, train station, bus station, shopping mall, medical office, or governmental office; and
the application is a video game.

10. The method of claim 1, wherein:
detecting the trigger event comprises identifying a location of the client device as being associated with a likelihood of subsequent loss of network connectivity by the client device; and
providing the recommendation comprises recommending an application that does not require network connectivity.

11. The method of claim 1, wherein:
detecting the trigger event comprises determining a location of the client device;
the providing is based further on a determination that one or more contacts of the user in the social-networking service are also present at the location; and
the application is a multi-user application.

12. The method of claim 1, wherein the trigger event is associated with use, on the client device, of an application that is independent of the social-networking service.

13. The method of claim 1, wherein providing the recommendation is performed based further on a determination that network connectivity for the client device satisfies a criterion.

14. The method of claim 1, wherein providing the recommendation is performed based further on a determination that movement of the client device satisfies a criterion.

15. The method of claim 1, further comprising selecting the application for recommendation to the user, from among a plurality of applications, based at least in part on one or more of:
a profile of the user in the social-networking service; and
a popularity of the application in the social-networking service.

16. The method of claim 1, further comprising selecting the application for recommendation to the user, from among a plurality of applications, based at least in part on the trigger event.

17. The method of claim 1, wherein providing the recommendation is performed based further on an activity level of the user with respect to using applications.

18. The method of claim 1, further comprising, before providing the recommendation:
monitoring activity of the user in the social-networking service; and
applying machine learning to the monitored activity to determine the trigger event.

19. An electronic device, comprising:
one or more processors; and
memory storing one or more programs for execution by the one or more processors, the one or more programs including instructions for providing a recommendation of an application to be installed or run on a client device of a user of a social-networking service, based at least in part on detection of a trigger event for the user.

20. A non-transitory computer-readable storage medium storing one or more programs for execution by one or more processors, the one or more programs including instructions for providing a recommendation of an application to be installed or run on a client device of a user of a social-networking service, based at least in part on detection of a trigger event for the user.
